(19) United States
(12) Patent Application Publication
(10) Pub. No.: US 2009/0171882 A1
(43) Pub. Date: Jul. 2, 2009

(54) DEVICE, SYSTEM, AND METHOD OF KNOWLEDGE PROPAGATION FOR LOGICAL PLATFORM CREATION

(76) Inventors: Barbara Rosario, Berkeley, CA (US); Roy Want, Los Altos, CA (US); Trevor Pering, San Francisco, CA (US)

Correspondence Address: Shiloh et al., C/O INTELLEVATE , LLC, P.O BOX 52050, MINNEAPOLIS, MN, 55402, US

(21) Appl. No.: 11/967,309

(22) Filed: Dec. 31, 2007

(51) Int. Cl. E05B 67/38; G06F 17/30

(52) U.S. Cl. 706/50; 707/204; 707/E17.001

(57) ABSTRACT

Device, system, and method of knowledge propagation for logical platform creation. For example, an apparatus includes: a Dynamically Composable Computing (DCC) engine to store DCC information; and a knowledge sharing manager to automatically exchange DCC information stored in the DCC engine with DCC information stored in another DCC engine of another apparatus.

### BACKGROUND

A user may utilize a first device, for example, a digital camera or a cellular phone, to capture photographs. The user may connect the first device to a second device, for example, a display unit or a printer, in order to present or print the captured photographs, respectively.

Unfortunately, the process of connecting or otherwise associating between the first device and the second device may be time-consuming, effort consuming, or error prone. Furthermore, the user may be required to re-perform the connection process in subsequent occasions. For example, it may be difficult and time consuming to manually assemble, compose and/or configure a wireless system having multiple wireless devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1A is a schematic block diagram illustration of a wireless communication system in accordance with some demonstrative embodiments of the invention.

FIG. 1B is a schematic block diagram illustration of a wireless communication system in accordance with some demonstrative embodiments of the invention.

FIG. 2 is a schematic block diagram illustration of a process of DCC information exchange among multiple devices in accordance with some demonstrative embodiments of the invention.

FIG. 3 is a schematic flow-chart of a method of knowledge propagation for logical platform creation, in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication. The term “wireless device” as used herein includes, for example, a device capable of wireless communication, a communication device capable of wireless communication, a communication station capable of wireless communication, a desktop computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like

Some embodiments of the invention may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.20, 802.21 standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (RTM), Global Positioning System (GPS), Wi-Fi, Wi-Max, ZigBee (TM), Ultra-Wideband (UWB), Global System for Mobile communication (GSM), 2G, 2.5G, 3G, 3.5G, Enhanced Data rates for GSM Evolution (EDGE), or the like. Embodiments of the invention may be used in various other devices, systems and/or networks.

Although portions of the discussion herein relate, for demonstrative purposes, to creation of logical platforms including at least one small device, portable device, handheld device or mobile device, embodiments of the invention may be used in conjunction with creation of logical platforms that do not necessarily include such devices, or that include one or more types of devices, for example, portable or non-portable devices, small or large devices, desktop devices, handheld devices, mobile or non-mobile devices, “Carry Small Live Large” (CSLL) devices, Ultra Mobile Devices (UMDs), Ultra Mobile PCs (UMPCs), devices that support Dynamically Composable Computing (DCC), context-aware devices, devices that are affixed to or mounted on an infrastructure (e.g., a display unit affixed to a wall), or the like.

The term “composition” as used herein includes, for example, a logical system or a computing system that includes multiple components, a platform or a logical platform that includes multiple components, an operable combination or assembly of multiple components, a system that includes multiple components able to communicate among themselves using wireless links and/or wired links, a logical platform tailored to performance of an activity or a task, or the like.

The terms “DCC information” or “DCC knowledge” or “DCC-related information” or “DCC-related knowledge” as used herein includes, for example, data describing an operation or activity which may be performed by one or more components of a composed system (e.g., watch movies, display photographs, edit photographs, or the like); data describing one or more compositions, or preferred compositions, or possible compositions, that are associated with one or more such operations or activities; data describing one or more instructions or machine-readable instructions, which may be used in order to deploy and/or activate a composed system in accordance with a particular composition; data describing a property or a characteristic associated with a composition (e.g., Quality of Service (QoS), power consumption, signal strength, or the like); data describing properties and/or characteristics associated with one or more devices forming a composition or able to participate in forming a composition; data describing properties or rankings of compositions; data indicating user preferences or user priorities with regard to one or more compositions (e.g., data indicating that a particular user prefers a composition “A, B, C” over a composition “A, B, D” for the operation “edit photographs”); and/or other data which may be generated, stored and/or utilized by a DCC engine or a DCC-supporting device.

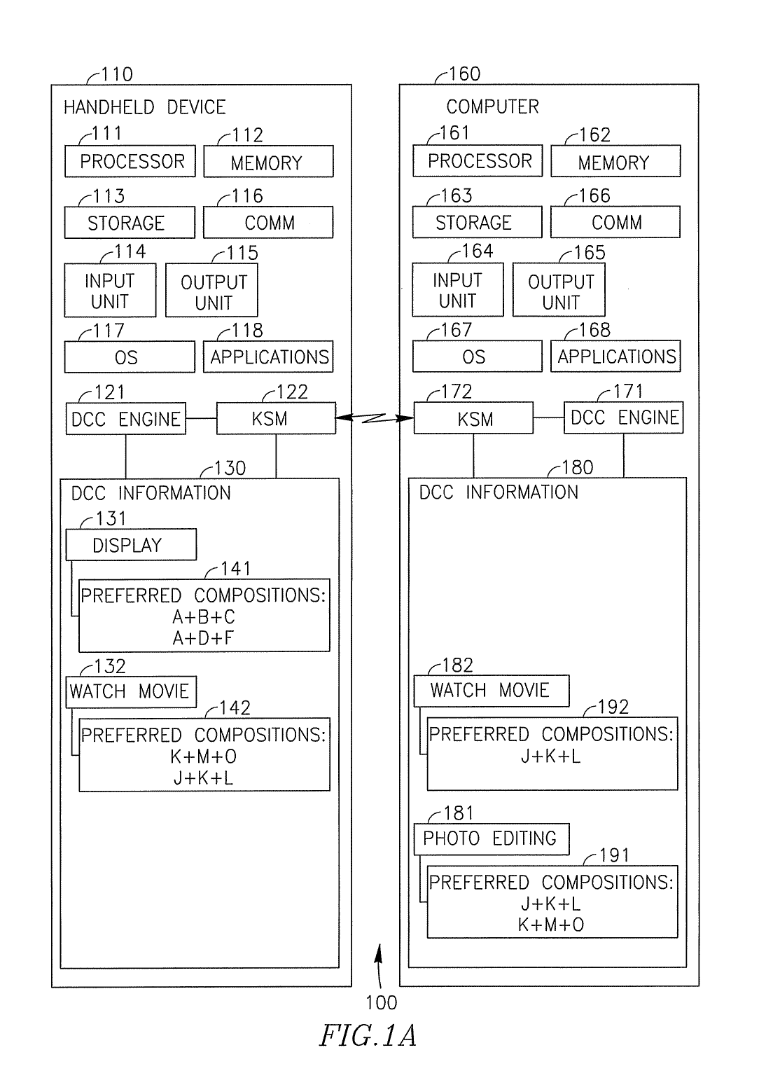

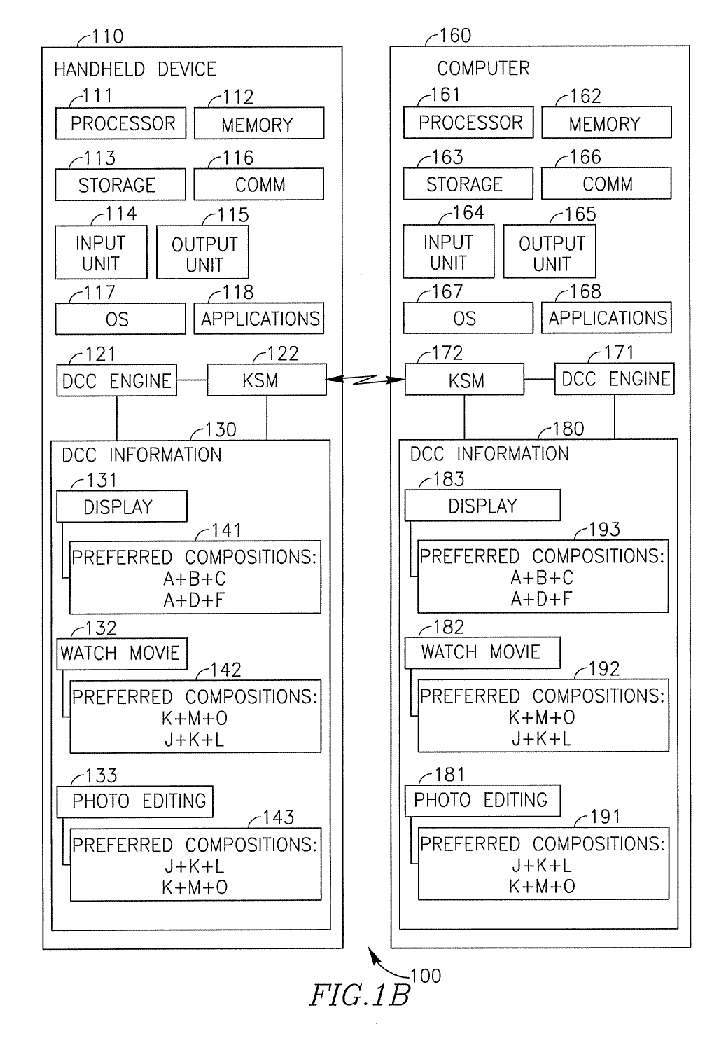

FIGS. 1A and 1B schematically illustrates a block diagram of a system 100 in accordance with some demonstrative embodiments of the invention. FIG. 1A shows the system 100 prior to DCC knowledge propagation, whereas FIG. 1B shows the system 100 subsequent to DCC knowledge propagation.

System 100 may utilize Dynamic Composable Computing (DCC) architecture to allow small mobile devices (e.g., CSLL devices) to dynamically create a logical computer platform from nearby wireless resources (e.g., a display unit, a storage unit, networking equipment, processing resources, or the like). For example, the DCC architecture of system 100 may be used to connect a portable display unit and a mobile storage unit to a desktop PC; or to connect a user's UMD to a physician's computer monitor and to medical test equipment.

The DCC architecture of system 100 may create compositions of components into logical platforms using composition instructions and using knowledge about “preferred” combinations. For example, the DCC architecture of system 100 may generate, propagate and/or utilize the knowledge that a first display unit operates better than a second display unit when used in conjunction with a particular mobile device; the knowledge that most users utilize a first set of devices (e.g., devices A, B and C) rather than a second set of devices (e.g., A, D and E) in order to perform a particular operation or type of operation (e.g., a medical examination); that in a particular location, a first storage device is typically used for multimedia storage, and that a useful composition for watching movies includes the first storage device, a particular display unit, and a particular set of speakers.

The DCC architecture of system 100 may be used to create general, effective and/or adaptive compositions of multiple components into logical platforms. The created compositions may depend on field experience or users experience (e.g., using periodically-updated statistic data) and/or on local knowledge about specific environments (e.g., location properties). In some embodiments, compositions may be automatically modified over time by system 100, which may be able to dynamically adapt to temporal changes.

The DCC architecture of system 100 thus allows to propagate and transfer such knowledge from a first environment to a second environment, or from a first device to a second device. The knowledge on composition instructions and preferred compositions may be propagated and updated in a decentralized manner, optionally using peer-to-peer communication mechanisms.

FIG. 1 includes, for example, a handheld device 110 (which may be referred to as device “A”) and a computer 160 (which may be referred to as device “C”). Handheld device 110 and desktop computer 160 may be associated, or may communicate, using wired and/or wireless links.

Handheld device 110 may be, for example, a cellular phone, a PDA device, a hybrid device (e.g., combining cellular phone functionalities with PDA device functionalities), a portable computer, or the like. Handheld device 110 includes, for example, a processor 111, a memory unit 112, a storage unit 113, an input unit 114, an output unit 115, a communication unit 116, an Operating System (OS) 117, and one or more applications 118.

Computer 160 may be, for example, a desktop computer, a PC, a laptop computer, a notebook computer, a tablet computer, a workstation, or the like. Computer 160 includes, for example, a processor 161, a memory unit 162, a storage unit 163, an input unit 164, an output unit 165, a communication unit 166, an Operating System (OS) 167, and one or more applications 168.

Handheld device 110 may support Dynamically Composable Computing (DCC), for example, by a software and/or hardware DCC engine 121. Similarly, computer 160 may support Dynamically Composable Computing (DCC), for example, by a software and/or hardware DCC engine 171. The DCC engines 121 and/or 171 may store and/or generate information about composition of logical platforms, about actual or operational compositions of logical platforms, and/or about possible or alternate compositions of logical platforms.

Handheld device 110 may include a software and/or hardware Knowledge Sharing Manager (KSM) 122, able to generate, transfer, import, export, propagate, exchange, compare, process, merge and/or utilize information about compositions of logical platforms. Similarly, computer 160 may include a software and/or hardware KSM 172, able to generate, transfer, import, export, propagate, exchange, compare, merge and/or utilize information about compositions of logical platforms. In some embodiments, only one of the two devices (the handheld device 110 and the computer 160) may include a KSM module, which may be able to communicate directly with the DCC engine of the other device. In some embodiments, the KSM module may be implemented as part of the DCC engine. In some embodiments, the KSM may be external to both devices (the handheld device 110 and the computer 160), for example, implemented using a wireless Access Point (AP).

In some embodiments, the KSMs 122 and 172 compare and exchange DCC-related data stored in the DCC engines 121 and 172. This may be performed, for example, once the handheld device 110 is connected to, or is associated with, the computer 160, or vice versa. DCC information stored in the handheld device 110, and not stored in the computer 160, may be copied from the handheld device 110 to the computer 160, and vice versa; thereby expanding the composition knowledge base of each device. In some embodiments, KSMs 122 and/or 172 may include algorithm or mechanism to handle contradictory information (e.g., an arbitration mechanism). In some embodiments, KSMs 122 and/or 172 may include algorithm or mechanism to generalize or contextualize the DCC-related information by taking into account one or more parameters, for example, coverage considerations, efficiency considerations, storage considerations, power considerations, or the like. In some embodiments, the algorithm may utilize or take into account context information or context-related information (e.g., nearby devices), location information or location-related information, or the like. In some embodiments, algorithms used by KSM 122 and/or 172 may utilize local DCC-related information (e.g., stored in the device performing the algorithm, or originally generated by the device performing the algorithm), and/or remote DCC-related information (e.g., stored in a device external to the device performing the algorithm, or imported or copied from such external device, or originally generated by such external device). In some embodiments, algorithms used by KSM 122 and/or KSM 172 may generate, or may utilize, ranking information, for example, ranking of compositions based on popularity or other criteria.

As shown in FIG. 1A, handheld device 110 initially includes DCC information 130, for example, DCC information about one or more operations or activities or tasks, namely, a task 131 (“Display”) and a task 132 (“Watch Movie”). Task 131 is associated with a list of preferred compositions 141 (a set of components “A, B, C”, and a set of components “A, D, F”). Similarly, task 132 is associated with a list of preferred compositions 142 (a set of components “K, M, O”, and a set of components “J, K, I”).

Similarly, computer 160 initially includes DCC information 180, for example, DCC information about one or more operations or activities or tasks, namely, a task 181 (“Photo Editing”) and a task 182 (“Watch Movie”). Task 181 is associated with a list of preferred compositions 191 (a set of components “J, K, L”, and a set of components “K, M, O”). Similarly, task 182 is associated with a list of preferred compositions 192 (a set of components “J, K, L”).

Once the handheld device 110 is connected to, or is associated with, the computer 160, or vice versa, the KSMs 122 and/or 172 operate to compare and resolve DCC information differences, and to determine which information items to transfer or copy from the handheld device 110 to the computer 160, or vice versa. For example, KSMs 122 and/or 172 may determine to transfer from handheld device 110 to computer 160 the entire list of preferred compositions 141 associated with task 131 (“Display”), which is included in handheld device 110 and is not included in computer 160. Similarly, KSMs 122 and/or 172 may determine to transfer from handheld device 110 to computer 160 a portion of the list of preferred compositions 142 associated with task 132 (“Watch Movie”); for example, the composition “K, M, O” which is included in handheld device 110 with an association to the “Watch Movie” task and is not included in computer 160 with an association to the “Watch Movie” task. Additionally, KSMs 122 and/or 172 may determine to transfer from computer 160 to handheld device 110 the entire list of preferred compositions 191 associated with task 181 (“Photo Editing”), which is included in computer 160 and is not included in handheld device 110.

As shown in FIG. 1B, subsequent to the information exchange, each one of devices 110 and 160 includes augmented DCC data, and is thus able to perform a greater number of composition tasks, or to offer to its user to select from a greater number of compositions. For example, the DCC information in handheld device 110 is augmented to include an additional task 133 (“Photo Editing”), with an additional list of preferred compositions 143 related thereto. Similarly, the DCC information in computer 160 is augmented to include an additional task 183 (“Display”), with an additional list of preferred compositions 193 related thereto. Additionally, the DCC information in computer 160 is updated such that the list of preferred compositions 182 is augmented to further include the composition “K, M, O”.

In some embodiments, handheld device 110 and/or computer 160 may further transfer and/or propagate the updated DCC information to other devices to which they are connected or associated. This allows the DCC information to be propagated continuously, efficiently, and in a decentralized manner.

In some embodiments, DCC knowledge propagation or DCC knowledge updates may be performed by KSMs 122 and/or 172 automatically and/or without user intervention. In other embodiments, the user may be advised that DCC knowledge exchange is performed. In still other embodiments, the DCC knowledge exchange may be performed subject to a specific approval of one or more users, or subject to a general pre-approval of one or more users.

In some embodiments, the DCC architecture of system 100 allows a user to show to other users a video item stored on the user's handheld device 110. Initially, the handheld device 110 may not include any instructions or data on how the user is able to show the video item on another device; and therefore initially, the users may be required to look at the small screen of the handheld device 110. In contrast, using DCC knowledge propagation, the DCC engine 121 of handheld device 110 is able to exchange information with another nearby DCC device (e.g., computer 160), to which it is connected; thereby obtaining the information that, for example, a portable DVD player is able to show the video item, and that a home theater speaker system is able to play the audio, as well as with the relevant instructions for performing this process. In some embodiments, for example, the composition of the DVD player, the speaker system and a handheld device was used one or more times in the particular location (e.g., a home) and was found to be useful, and therefore the system records and subsequently shares this DCC information with the handheld device 110. Accordingly, the handheld device now has the additional DCC information; once the user visits the same location, or once the user is locate in proximity to other similar devices (e.g., of the same type or brand), the user may be notified that the user is able to show the video using an improved composition of devices, and the system will have the required information to perform the process. The handheld device 110 may operate as DCC knowledge propagator to further propagate the added DCC information to other DCC devices, thereby expanding the utilization of such DCC information.

In some embodiments, substantially all DCC-related information is transferred or propagated among devices. In other embodiments, general or user-independent DCC information is transferred or propagated among devices; whereas user-specific DCC information, or user-specific preferences are not transferred and not propagated, but are maintained locally stored on the user's device.

In some embodiments, one or more levels of generality or specificity may be used in conjunction with DCC information being propagated, or in conjunction with devices or types of devices that exchange DCC information. In some embodiments, DCC information may be exchanged based on device types; for example, handheld devices may be configured to exchange information with computers, or vice versa. In other embodiments, more specifically, DCC information may be exchanged based on particular device types; for example, cellular phone may be configured to exchange DCC information with laptop computers, or vice versa (and not with a PDA device or with a desktop computer). In still other embodiments, DCC information may be exchanged based on particular device brands or manufacturers; for example, DCC information may be exchanged only among Nokia cellular phones, or only among Dell laptops, or only among devices including an Intel processor, or only between a Nokia cellular phone and a Dell laptop. In yet other embodiments, DCC information may be exchanged based on particular device models; for example, DCC information may be exchanged only among Nokia cellular phones having model numbers 6000, 6010, and/or 6020. In still other embodiments, DCC information may be exchanged based on particular hardware requirements or software requirements; for example, DCC information may be exchanged only among devices that utilize a Microsoft Windows operating system, or only among devices that support a particular file system, or only among devices that use 32-bit architecture. In still other embodiments, DCC information may be exchanged based on MAC addresses, based on identification of actual physical devices (e.g., optionally taking into account location preferences), or the like. In some embodiments, DCC information may be shared based on one or more properties of the owner(s) and/or users of a particular device; for example, DCC information stored in a particular device may be shared only among users that are defined as friends or “contacts” by the user of the particular device, or only among users that appear as “contacts” in a phone-book application of the particular device. Some embodiments may support multiple levels of generality, e.g., in the alternate or simultaneously.

In some embodiments, “preferred” compositions may include, for example, one or more compositions that are used the most (e.g., based on statistical usage counts); or compositions that were recommended by users, or were found to be successful accordingly to a quality indicator or a success indicator (e.g., ease of use, power consumption, Quality of Service (QoS) parameters, signal strength, dropped frames, lost packets, or the like). In some embodiments, preferred compositions may be associated with location preferences; for example, preferred compositions associated with a particular environment or location, a home network, a medical lab, or the like. In some embodiments, preferred compositions may be associated with task-oriented preferences; for example, preferred compositions associated with a particular task, e.g., watching a movie, or editing a photograph. Other criteria may be used to define or utilized “preferred” composition(s).

In some embodiments, the KSMs 122 and/or 172 are able to perform one or more operations, for example: to merge, add or augment composition instructions and/or preferred compositions found in nearby devices; avoiding duplicate DCC information, or removing duplicate DCC information; compressing DCC information or generalizing DCC information if possible (e.g., generalizing from a device model to a device type, or generalizing from a device model to a device brand); maintaining and/or updating statistics (e.g., about usage counts, user recommendations, or other parameters); storing and tracking the popularity of a composition; ordering the composition lists for each task, for example, based on popularity or other parameters; storing contexts associated with compositions (e.g., “my home”, “my office”, “my friend's home”); storing and tracking popularity of compositions for a particular context, or storing and tracking location-based composition preferences; deleting or removing unused compositions; deleting or removing compositions that appear to be non-useful or unpopular, or inferior to other compositions (e.g., more popular, or more frequently used); and/or identifying new trends, for example, by dynamically determining new compositions that include new devices.

Some embodiments may effectively propagate the most relevant information for a particular type of users or among a particular group of users. For example, users of a common type or of similar types (e.g., colleagues at work, teenage users at school, hospital employees, or the like) may prefer to do, or may be required to do, similar tasks, and/or may be in proximity to each other more often than users that have different interests. Some embodiments may thus efficiently propagate useful DCC information within a “social group” of users.

Some embodiments allow to automatically create intuitive, seamless, and effective compositions having multiple connections among multiple devices, for example, instead of manual one-by-one connection creation. Some embodiments allow to efficiently create compositions in unfamiliar environments or at unfamiliar environments, since information on possible or preferred compositions is automatically communicated among devices; and the user is not required to manually specify or determine composition details.

Some embodiments thus allow automatic transfer of DCC information for dynamic creation of logical platforms or compositions, in a process transparent to the user. The KMS modules provide multiple functions (data merging, deletions, generalizations, or the like), and the mechanism for automatic DCC data transfer allows substantially continuous and decentralized DCC data propagation.

Some embodiments allow to transfer or exchange DCC information among devices, without specifying (e.g., manually, by the user, or on a case-by-case basis) the information to be transferred, the origin and the destination of the transfer; and without the need to separately perform data synchronization among devices. In contrast with some backup systems that perform automatic data transfer and data synchronization at pre-defined time intervals, some embodiments automatically and dynamically exchange DCC information among devices that are not necessarily pre-defined, pre-setup or pre-specified.

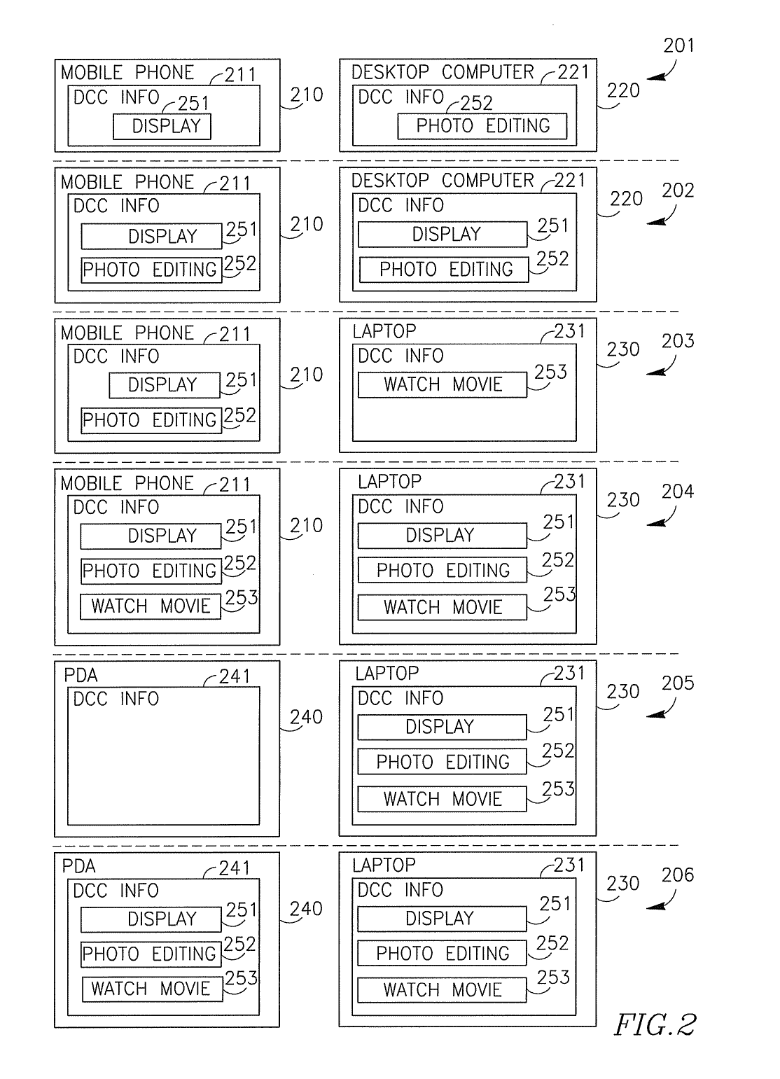

FIG. 2 schematically illustrates a block diagram of a process of DCC information exchange among multiple devices 210, 220, 230 and 240, in accordance with some demonstrative embodiments of the invention. For demonstrative purposes, the DCC information exchange is shown using six stages 201-206.

As shown in stage 201, a mobile phone 210 initially stores DCC information 211 including composition information 251 about “Display” activity. A desktop computer 220 initially stores DCC information 221 including composition information 252 about “Photo Editing” activity.

As shown in stage 202, the mobile phone 210 and the desktop computer 220 are connected and exchange DCC information, using one or more KSMs. Subsequent to the exchange, the DCC information 211 of mobile phone 210 includes composition information 251 about “Display” activity, as well as composition information 252 about “Photo Editing” activity. Similarly, subsequent to the exchange, the DCC information 221 of desktop computer 220 includes composition information 251 about “Display” activity, as well as composition information 252 about “Photo Editing” activity.

As shown in stage 203, the mobile phone 210 is now in proximity to a laptop computer 230. The laptop computer 230 initially stores DCC information 231 including composition information 253 about “Watch Movie” activity.

As shown in stage 204, the mobile phone 210 and the laptop computer 230 are connected and exchange DCC information, using one or more KSMs. Subsequent to the exchange, the DCC information 211 of mobile phone 210 includes composition information 251 about “Display” activity, composition information 252 about “Photo Editing” activity, and composition information 253 about “Watch Movie” activity. Similarly, subsequent to the exchange, the DCC information 231 of laptop computer 230 includes composition information 251 about “Display” activity, composition information 252 about “Photo Editing” activity, and composition information 253 about “Watch Movie” activity.

As shown in stage 205, the laptop computer 230 is now in proximity to a PDA 240. The PDA initially stores DCC information 241 which does not yet include any composition information items.

As shown in stage 206, the laptop computer 230 and the PDA 240 are connected and exchange DCC information, using one or more KSMs. Subsequent to the exchange, the DCC information 231 of laptop computer 230 includes composition information 251 about “Display” activity, composition information 252 about “Photo Editing” activity, and composition information 253 about “Watch Movie” activity. Similarly, subsequent to the exchange, the DCC information 241 of PDA 240 includes composition information 251 about “Display” activity, composition information 252 about “Photo Editing” activity, and composition information 253 about “Watch Movie” activity.

As demonstrated, the laptop computer 230 acquired, through mobile phone 210, the composition information 252 about “Photo Editing” activity which originally resided only on desktop computer 220; although the laptop computer 230 was not connected with the desktop computer 220. Similarly, the PDA 240 acquired from laptop computer 230 the composition information 251-253, originating in multiple sources (the mobile phone 210, the desktop computer 220, and the laptop computer 230), although the PDA 240 was not connected with the desktop computer 220 or the mobile phone 210.

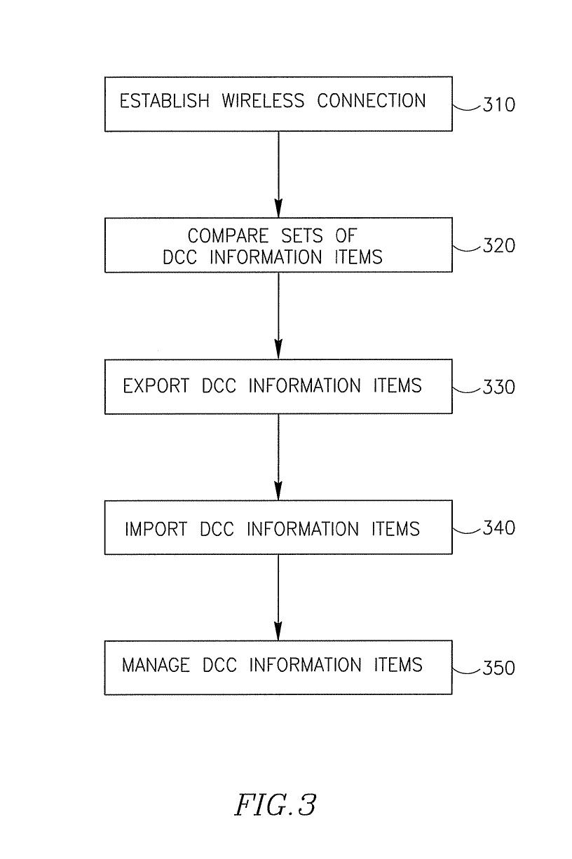

FIG. 3 is a schematic flow-chart of a method of knowledge propagation for logical platform creation, in accordance with some demonstrative embodiments of the invention. Operations of the method may be used, for example, by system 100 of FIGS. 1A-1B, by KSMs 171-172 of FIGS. 1A-1B, and/or by other suitable devices or systems.

In some embodiments, the method may optionally include, for example, establishing a wireless connection or a wireless association between a first device and a second device (block 310). This may include, for example, automatically detecting by the first device that the second device is in proximity to the first device, and/or that the first and second devices are capable of communicating through a wireless medium.

In some embodiments, the method may optionally include, for example, comparing between a first set of DCC information items, stored in the first device, and a second set of DCC information items, stored in the second device (block 320).

In some embodiments, the method may optionally include, for example, exporting from the first device to the second device DCC information items that are stored in the first device and are not stored in the second device (block 330).

In some embodiments, the method may optionally include, for example, importing from the second device to the first device DCC information items that are stored in the second device and are not stored in the first device (block 340).

In some embodiments, the method may optionally include, for example, managing the set of DCC information items stored in the first device (block 350). This may include, for example, logging or tracking statistics of utilization of system compositions, tracking popularity of system compositions, sorting system compositions, deleting unpopular or unused system compositions, modifying (e.g., increasing or decreasing) a generalization level of a system composition, or performing other suitable operations with regard to DCC information items and their utilization or propagation.

In some embodiments, one or more of the above-mentioned operations may be repeated, for example, periodically, substantially continuously, at pre-defined time intervals, based on pre-defined conditions or criteria, or the like.

Other operations or sets of operations may be used in accordance with some embodiments of the invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a Dynamically Composable Computing (DCC) engine to store DCC information; and
a knowledge sharing manager to automatically exchange DCC information stored in the DCC engine with DCC information stored in another DCC engine of another apparatus.

2. The apparatus of claim 1, wherein the DCC information comprises one or more information items selected from the group consisting of:
information describing an activity to be performed by a composed system;
information describing components of a composed system;
information describing instructions to compose a composed system; and
information describing a property of a composed system.

3. The apparatus of claim 1, wherein the knowledge sharing manager is to compare the DCC information stored in the DCC engine with the DCC information stored in the other DCC engine.

4. The apparatus of claim 3, wherein the knowledge sharing manager is to import to the DCC engine remote DCC information stored in the DCC engine of the other apparatus and not stored locally in the DCC engine of said apparatus.

5. The apparatus of claim 3, wherein the knowledge sharing manager is to export to the DCC engine DCC information stored locally in the DCC engine of said apparatus and not stored in the remote DCC engine of the other apparatus.

6. The apparatus of claim 3, wherein the knowledge sharing manager is to add, to a list of system compositions locally stored in the DCC engine, a system composition stored remotely in the DCC engine of the other apparatus.

7. The apparatus of claim 3, wherein the knowledge sharing manager is to log statistical data of utilization of a system composition stored in the DCC engine, and to determine a popularity of the system composition.

8. The apparatus of claim 3, wherein the knowledge sharing manager is to log statistical data of utilization of system compositions stored in the DCC engine, to determine popularity of the system compositions based on the statistical data, and to sort the system compositions based on popularity, and to selectively delete an unpopular system composition from a list of system compositions stored in the DCC engine.

9. The apparatus of claim 3, wherein the knowledge sharing manager is to read a DCC information item stored remotely in the DCC engine of the other apparatus, to convert the DCC information item from a first generalization level to a second, different, generalization level, and to locally store the converted DCC information item in the DCC engine of said apparatus.

10. The apparatus of claim 1, wherein the apparatus comprises a device selected from the group consisting of: a desktop computer, a laptop computer, a cellular phone, a handheld device, and a Personal Digital Assistant device.

11. A method comprising:
comparing between a first set of Dynamically Composable Computing (DCC) information items stored on a first wireless device and a second set of DCC information items stored on a second wireless device;
copying from the first wireless device to the second wireless device one or more DCC information items stored on the first wireless device and not stored on the second wireless device;
copying from the second wireless device to the first wireless device one or more DCC information items stored on the second wireless device and not stored on the first wireless device.

12. The method of claim 11, comprising:
logging statistical data of utilization of the DCC information item stored on the first wireless device;
determining popularity of the DCC information items stored on the first wireless device; and
sorting the DCC information items stored on the first wireless device based on the determined popularity.

13. The method of claim 12, comprising:
selectively deleting at least one of the DCC information items stored on the first wireless device based on the determined popularity.

14. The method of claim 11, comprising:
modifying a level of generalization of at least one DCC information item stored on the first wireless device.

15. The method of claim 11, wherein the DCC information items comprise information items selected from the group consisting of:
information describing an activity to be performed by a composed system;
information describing components of a composed system;
information describing instructions to compose a composed system; and
information describing a property of a composed system.
